(19) United States
(12) Patent Application Publication
(10) Pub. No.: US 2003/0154208 A1
(43) Pub. Date: Aug. 14, 2003

(54) Medical data storage system and method

(75) Inventors: Oded Maimon, Nir Zvi (IL); Elie Ezer, Kfar Yehoshua (IL); Lior Rokach, Kfar Saba (IL); Mordechai Averbuch, Holon (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: MEDDAK LTD

(21) Appl. No.: 10/365,405

(22) Filed: Feb. 13, 2003

Related U.S. Application Data
(60) Provisional application No. 60/356,145, filed on Feb. 14, 2002.

(51) Int. Cl. G06F 7/00

(52) U.S. Cl. 707/100

(57) ABSTRACT

A method and a device for storing medical data from medical records and subsequently extracting knowledge and information are disclosed. Data is continuously stored in a database, while knowledge accumulated in an accompanying medical dictionary and an accompanying medical knowledge directed acyclic graph.

### FIELD AND BACKGROUND OF THE INVENTION

The present invention relates to the field of information management, and specifically to a method and a device for storing and managing medical data, while increasing medical knowledge and information. The present invention provides for identification of patients belonging to a selected group of patients. Further, the present invention provides for a method and a device for selecting persons for participation in clinical research.

There is much data relating to patient history stored in medical institutions. The amount and complexity of the data makes it difficult to access and to mine for knowledge. Standard methods of storing and arranging data, involving dedicated forms with mandatory fields and a common language are not implementable: doctors and other medical personnel do not readily accept the need to invest time to use such methods. In addition, hospital administrators are unlikely to hire personnel whose only function is to input data into a detailed clinical database.

Even if the issue of data input is solved, an ideal structure for a medical database is not obvious. A medical file of any one patient contains many, sometimes-interrelated sometimes-unrelated facts, written in a plurality of medical reports. Medical data is rarely exact, containing ambiguous terms, hypotheses such as attempted treatments and tests with ambiguous results. A single patient may have a large numbers of symptoms, diagnosed and undiagnosed medical conditions and a multitude of unrelated treatments. Classification of the data relating to any one patient is a task for which prior art database structures are ill suited. Prior art database structures used in the field of medical information management necessarily lose information and are expensive to maintain.

Even if patient data were somehow stored in a prior art database structure, SQL database query language, due to the ambiguity, interconnectedness and complex relationships of medical data, is insufficient for providing a rigorous answer except for the most simple of queries. As a result, when an exact answer is required, manual expert review of many records, one by one, is required.

An example of the complexity of medical data and insufficiency of data storage is seen when patient recruitment for clinical trials is required. Patient recruitment is time-consuming task as investigators and researchers try to identify patients with a profile appropriate for a given clinical trial. Generally prior art recruitment methods fall into two categories. The first is manual review by a highly skilled researcher of numerous patient records. Beyond the time and expense manual review requires, patient privacy is compromised. The second method, using mass media outreach is inefficient, expensive and unpredictable.

It would be highly advantageous to have a method for easily storing medical data without losing medical information, the method allowing efficient recovery of the information when needed.

### SUMMARY OF THE INVENTION

The above and other objectives are achieved by the methods and device of the present invention.

According to the teachings of the present invention there is provided a software system for accessibly storing information from medical data, the software system fixed in a machine readable medium, the software system comprising:

a) a dictionary of terms, each one of the terms having no more than one meaning;

b) a relational database storing person-dependent (that is patient dependent) data; and

c) an directed acyclic graph including nodes and links between pairs of nodes wherein:

i. a node represents one term from the dictionary; and

ii. a link between two nodes represents a finite probability (substantially greater than 0) that the two terms represented by the two respective nodes coappear in a record of a person in the database.

wherein each database record in the database corresponds to a single person (patient) and some of the medical terms are attributes in the database.

According to a feature of the system of the present invention each one of the terms in the dictionary is classified as belonging to a category. According to a further feature of the present invention, associated with the terms (some or all of the terms) is a respective term appearance probability, where any given term appearance probability is related to a probability that a respective term appears in a record of a person in the database. According to a still further feature of the present invention, a term appearance probability is at least in part dependent on the number of times a respective term appears in said database. According to a still further feature of the present invention, a term appearance probability is at least in part dependent on an a priori probability that a respective term appears in a record of a person in the database.

According to a feature of the system of the present invention, associated with a link in the directed acyclic graph (each link or only some of the links) is a respective term coappearance probability, a term coappearance probability being related to a probability that the two terms corresponding to the two nodes connected by the respective link coappear (both appear) in a record of a person in the database. According to a feature of the system of the present invention the term coappearance probability is dependent on the number of times the two respective terms coappear in a record of a person in the database.

According to a feature of the present invention, the system of the present invention further comprises: d) a data input module configured to input a patient record (preferably a free-form patient record), extract salient data from the patient record, and to store the salient data in the database.

According to a feature of the present invention, the system of the present invention further comprises: e) a relationship identifying module configured to determine a relationship probability, the relationship probability being related to a probability that a nonappearing term (a nonappearing term being a term that does not appear in a record of a specific person in the database) is applicable to that specific person.

Also provided according to the teachings of the present invention is a method for accessibly storing medical data comprising:

a) providing a dictionary of terms, each one of the terms having no more than one meaning;

b) providing a relational database wherein each database record in the database corresponds to a single person (patient) and some of the medical terms are attributes in the database;

c) describing relationships between the terms using a directed acyclic graph made up of nodes and links between pairs of nodes wherein:

i. a node represents a term; and

ii. a link between two nodes represents a finite probability (substantially greater than 0) that the two terms represented by the two nodes coappear in a database record of a person in the database;

d) for a plurality of persons, from at least one medical record relating to each one of the persons, extracting at least one data item from the at least one medical record, wherein a data item indicates the applicability of at least one of the plurality of medical terms to a respective person; and

e) storing the extracted data items in the relational database.

According to a feature of the method of the present invention each one of the terms in the dictionary is classified as belonging to a category. According to a further feature of the method of the present invention, associated with the terms (some or all of the terms) is a respective term appearance probability, where any given term appearance probability is related to a probability that a respective term appears in a record of a person in the database According to a still further feature of the method of the present invention, a term appearance probability is at least in part dependent on the number of times a respective term appears in said database. According to a still further feature of the method of the present invention, a term appearance probability is at least in part dependent on an a priori probability that a respective term appears in a record of a person in the database.

According to a feature of the method of the present invention, associated with a link in the directed acyclic graph (each link or only some of the links) is a respective term coappearance probability, a term coappearance probability being related to a probability that the two terms corresponding to the two nodes connected by the respective link coappear (both appear) in a record of a person in the database. According to a feature of the method of the present invention the term coappearance probability is dependent on the number of times the two respective terms coappear in a record of a person in the database.

According to a feature of the method of the present invention the at least one medical records are free-form medical record.

Herein the following conventions will be used to described probability:

P(t) indicates the probability that term t is true for a given patient;

P(t|a) indicates the probability that term t is true for a given patient having an attribute value a;

P(t₁, t₂) indicates the probability that both the term t₁ is true and the term t₂ is true; and

P(t₁|t₂, . . . , tₙ) indicates the probability that term t₁ is true if t₂, . . . , tₙ are true for a given patient.

### BRIEF DESCRIPTION OF THE DRAWINGS

The invention is herein described, by way of example only, with reference to the accompanying drawings, wherein:

FIG. 1 is a block diagram of a data processing system suitable for operating software embodying aspects of the invention;

FIG. 2A depicts a patient table of a database according to an embodiment of the present invention;

FIGS. 2B-2G are depictions of category tables of a database according to an embodiment of the present invention;

FIG. 3 depicts a medical knowledge directed acyclic graph (MKDAG) according to an embodiment of the present invention;

FIG. 4 depicts a preferred method of implementing an MKDAG of the present invention as a table of cross terms tₐ and t_{b};

FIG. 5 lists selected medical patterns from a medical pattern list of the present invention;

FIG. 6 is of a process flow diagram of a typical embodiment of a free-form text data input module of the present invention;

FIG. 7 is an illustrative example of a query input interface suitable for use with the present invention; and

FIG. 8 depicts the result of a query as a plurality of condition score vectors.

### DETAILED DESCRIPTION OF THE INVENTION

The present invention is of a method and a device for storing medical data from medical records and subsequently extracting information. By extracting information is meant, for example, epidemiology, identifying patient subpopulations (e.g. for clinical studies) and identifying unsuspected relationships between medical terms. The core of the invention is the combination of a medical dictionary, a patient record database and a directed acyclic graph linking related medical terms (MKDAG—medical knowledge directed acyclic graph). Beyond information extraction, the combination of the medical dictionary, the database and the MKDAG of the present invention allows fine-tuning and increase of medical knowledge relating to a specified location, for example for a hospital or a country. The utility of the invention is increased by the input of data from unformatted medical records such as free text physician reports.

The principles and use of the present invention are better understood with reference to the drawings and description hereinbelow.

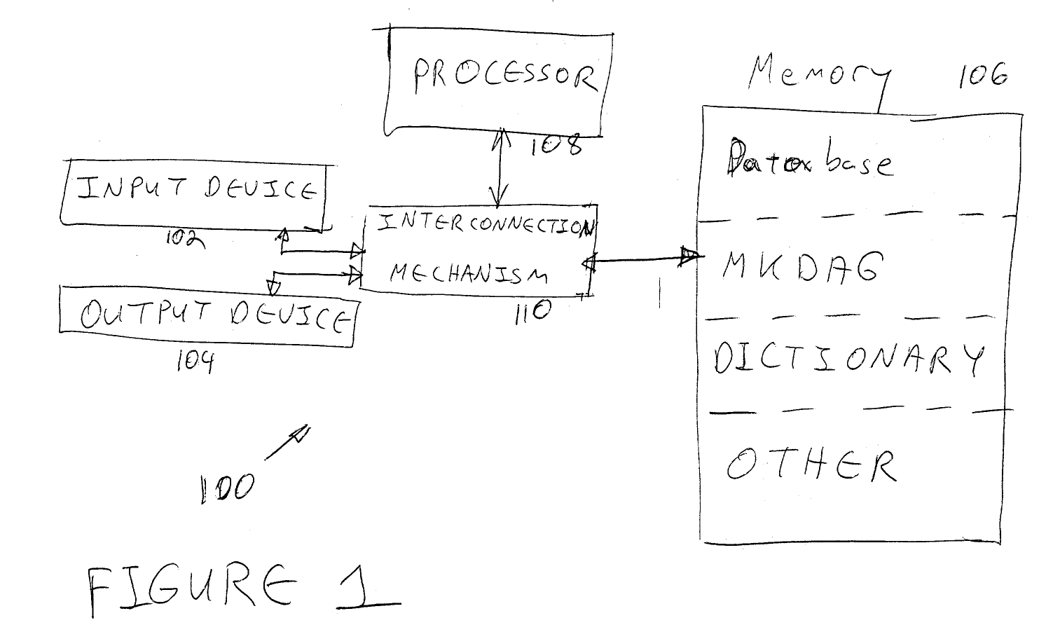

A device of the present invention is generally one or more data processing systems configured to perform the method of the present invention by executing one or more software programs implementing the present invention, for example as depicted in FIG. 1.

In FIG. 1 a data processing system 100 is depicted as having input devices 102 (e.g. mouse, keyboards), output devices 104 (e.g. display screens, printers), memory devices 106 (e.g. hard disks) and processors 108 all communicating through interconnection mechanism 110. In some cases input and output functions are integrated into one physical device (e.g. touch-sensitive screens). In memory devices 106 are stored data structures of the present invention such as the patient record database, the MKDAG and the medical dictionary. Also stored in memory devices 106 are other necessary or important information such as processor executable software programs for performing processes and tasks required in practicing the present invention as well as for realizing the modules described herein.

The entire device 100 depicted in FIG. 1 may be realized, for example, as a self-standing computer (e.g. personal computer, mini-computer, mainframe computer) or, for example, as part of a computer network (e.g. a network or computers, a server computer with terminals, an intranet or the Internet).

According to the present invention, knowledge, information and patient data are stored in three primary data structures:

i. a medical dictionary containing terms, each term belonging to a category of terms;

ii. a relational database containing patient data; and

iii. a MKDAG containing prior and acquired knowledge;

and in a preferred embodiment also structures for aiding in the storage of input data including

iv. a medical synonym list; and

v. a medical record pattern list.

The knowledge and data are manipulated with a number of modules preferably including:

i. an actual probability module, returning the probability of a term being related to a patient for implementing one aspect of learning in the present invention;

ii. a coappearance probability module, returning the probability of any two terms both being related to a single patient;

iii. a data input module (preferably from free-form text documents) configured to store patient data in the relational database using the MKDAG and the dictionary, and in the process increase the information and knowledge contained in the MKDAG and the dictionary;

iv. a system initiated data request module;

v. a relationship identifying module to maintain the MKDAG and identify significant unidentified knowledge; and

vi. a query module using the MKDAG and the relational database to perform medical data queries, comprising:

a query composition module; and

a query compiler module.

Knowledge and Data Structures

Medical Dictionary

The medical dictionary of the present invention is a listing of medical terms. Each term in the medical dictionary of the present invention has only one meaning. The more comprehensive the dictionary is, that is the greater the number of medical terms are included, the greater the utility of the dictionary. Each term in the dictionary is classified as belonging to a category. Although in principle the exact nature of the categories is not important, in a preferred embodiment of the present invention categories include Medication, Diagnosis, Lab, Behavior, Procedure, Symptom and Units.

In most, but not necessarily all, cases associated with a term t is a probability P(t) representing the a priori probability of a term t being applicable to a patient. For example, associated with the term Inflammatory Bowel Disease is P(Inflammatory Bowel Disease), the a priori probability of any patient being diagnosed as having Inflammatory Bowel Disease. Preferably a term is associated with a plurality of probabilities P(t, a) each representing the a priori probability of a term t being applicable to a patient when the patient has some value of an attribute a, such as age, gender and the like. For example P(Inflammatory Bowel Disease, age) represents the a priori probability of a patient of a certain age as being diagnosed with Inflammatory Bowel Disease.

Associated with each probability P is a strength factor S. S has units of patients. The higher S is, the more believable and more “true” the associated a priori probability term is. S is determined from the literature or by a medical expert.

Also associated with each probability P is a counter C. C has units of patients and is an actual count of patients with data stored in the system of the present invention that have been identified as being associated with that term. The utility of P(t) or P(t, a), S and C is discussed hereinbelow.

In the medical dictionary terms that belong to the Unit category do not have an associated P(t), S or C. As is described herein, terms of the Unit category are used in understanding input text. In embodiments of the present invention, other categories of terms may exist that have no associated P(t), S or C.

Clearly, it is most advantageous that the dictionary be updateable, (for example that new terms can be added) for example by a system administrator. The use of a dictionary of the present invention is described fully hereinbelow. Methods of implementing a dictionary as described herein are well known to one skilled in the art.

Relational Database for Storing Patient Related Data

The relational database of the present invention optimally stores medically significant (salient) data found in patient medical records. Each record in the database belongs to a single identifiable patient. The attributes of the database are generally terms or are associated with terms and include medically relevant information gleaned from medical records.

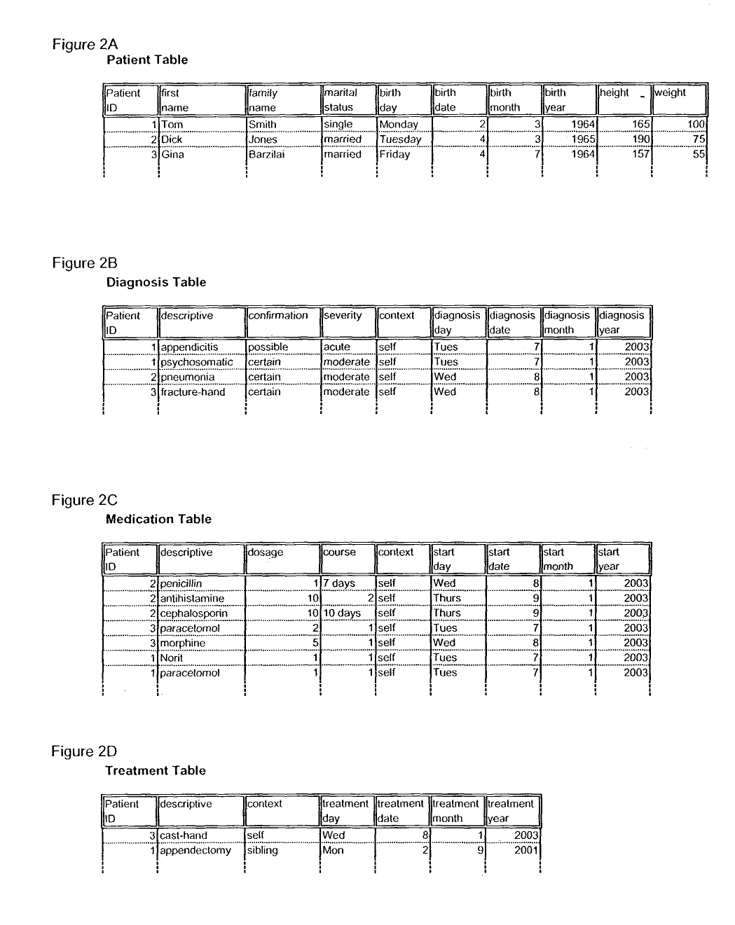

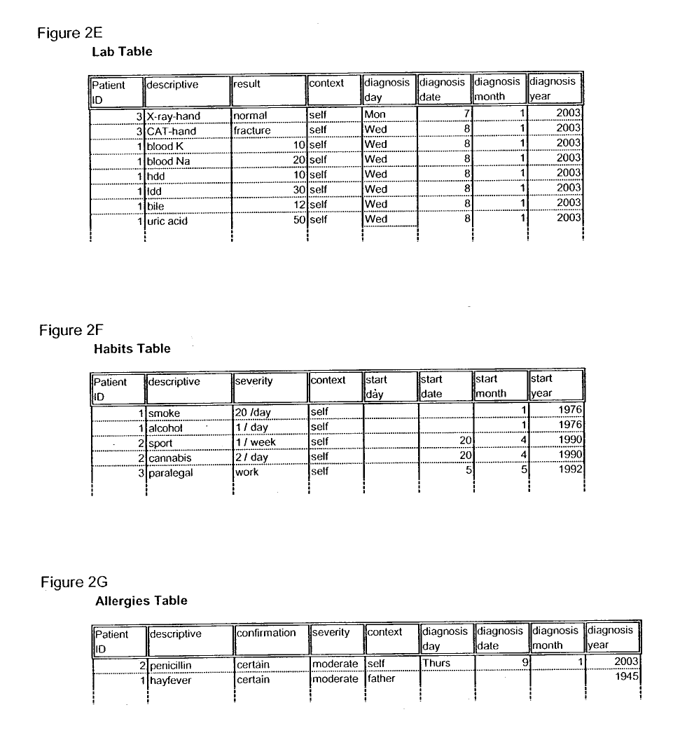

In a preferred embodiment of the present invention the database comprises a first patient table (FIG. 2A) and one or more category tables (FIGS. 2B-2G).

For each patient there is but one record in the patient table. The attributes of the patient table include, in addition to a unique patient identification, general patient data such as name, birth day, birth year, marital status, weight and the like.

The database also comprises a plurality of category tables. In one embodiment, for example, for six of the categories listed hereinabove there is a respective database table. The six category tables are Diagnosis (FIG. 2B), Medication (FIG. 2C), Treatment (FIG. 2D), Lab (FIG. 2E), Habits (FIG. 2F) and Allergies (FIG. 2G). There is no table for the Units category. In the category tables there are any number of records for each patient. Each record has a patient identification attribute, an appropriate descriptive attribute, and modifying attributes that are related to the descriptive attribute.

The value of a cell of a descriptive attribute is a term found in the dictionary of the present invention.

The value of a cell of a modifying attribute is generally a commonly used adjectives, modifier or descriptor used by medical personnel in explaining a term. For any one descriptive attribute there may be one or more modifying attributes. The meaning of any given modifying attributes is dependent on the category of the table.

One modifying attribute is a date attribute (that is implemented as either a single attribute, or as atomic day, date, month and year attributes).

Another modifying attribute is a context attribute which generally designates whether the descriptive attribute refers to the patient or to a relative (vide infra). The value of a cell of a context attribute designates what the relation is of the patient to the person to which the descriptive attribute relates. Such values include the patient self, mother, father, sibling and so forth.

A record in the diagnosis table (FIG. 2B) describes what diagnosis was made (descriptive attribute), when the diagnosis was made (date attribute), the person who was diagnosed (context attribute), the certainty of the diagnosis (confirmation attribute) and the severity of the diagnosis (severity attribute). Each separate diagnosis related to each patient appears as a separate record in the diagnosis table.

A record in the medication table (FIG. 2C) describes what medication was administered (descriptive attribute), when the course of medication was started (date attribute), the person who took the medication (context attribute), the dosage (dosage attribute), and the length of time (course attribute) the medication was taken. Each separate medication related to each patient appears as a separate record in the medication table.

A record in the treatment table (FIG. 2D) describes a treatment (descriptive attribute), e.g. surgery, physiotherapy, when the treatment was performed (date attribute) and the person who was treated (context attribute). Each separate treatment related to each patient appears as a separate record in the treatment table.

A record in the lab table (FIG. 2E) describes a laboratory test (descriptive attribute), e.g. imaging (CAT, MRI, U/S) and chemical (blood test, stool test), when the test was performed (date attribute), the person who was tested (context attribute) and the results (result attribute). Each separate test result related to each patient appears as a separate record in the lab table. For example, if in a single blood test levels of 6 different chemicals are measured, the results of each of the 6 different chemicals appear as a separate record in the lab table.

A record in the habits table (FIG. 2F) describes a habit (descriptive attribute), e.g. tobacco smoking, chemical abuse, when the habit was identified (date attribute) the person who has the habit (context attribute) and the severity of the habit (severity attribute). Each separate habit related to each patient appears as a separate record in the habit table.

A record in the allergy table (FIG. 2G) describes an allergy (descriptive attribute), when the allergy was identified (date attribute), the person who has the allergy (context attribute) and the severity of the allergy (severity attribute). Each separate allergy related to each patient appears as a separate record in the allergy table.

The attributes listed above for each category are clearly just examples and in a specific implementation it may be desirable to add one or more attributes to a specific category table.

MKDAG

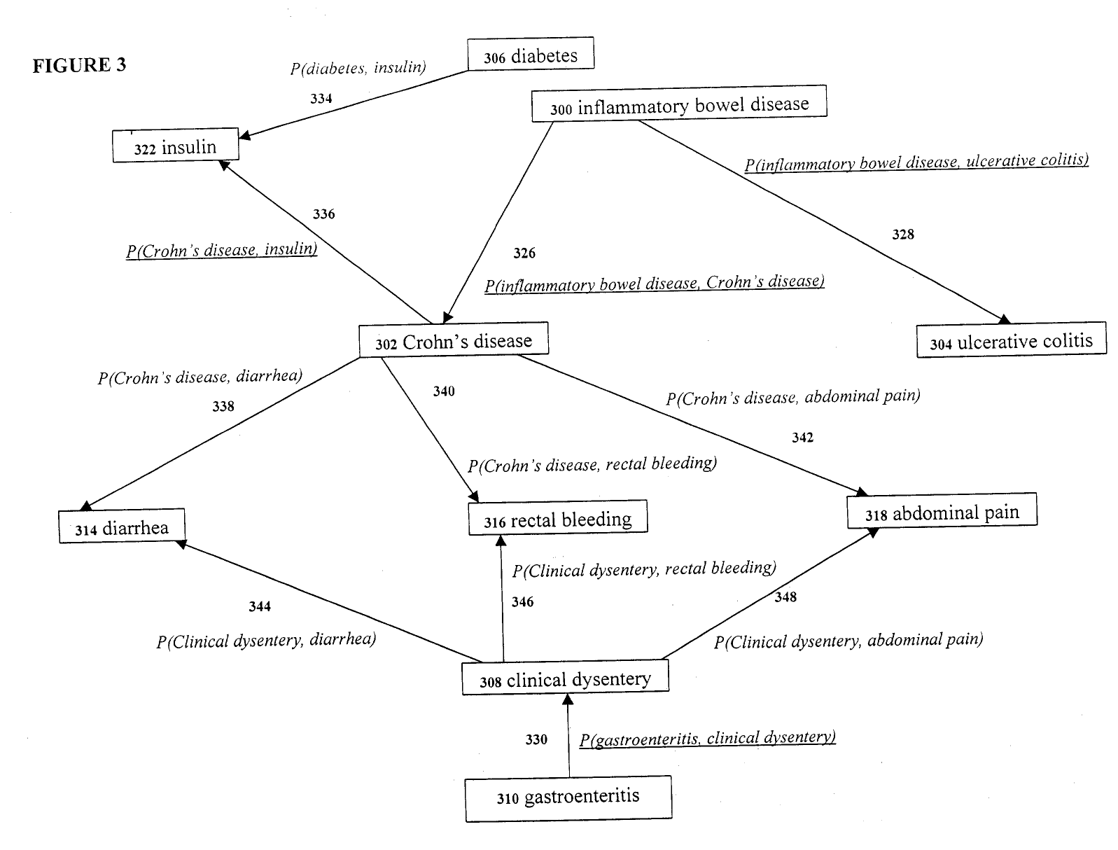

The third critical storage component of the present invention is a medical knowledge directed acyclic graph (MKDAG). An MKDAG is schematically depicted in FIG. 3. An MKDAG is used in the present invention to store, in an easy to reference manner, the relationships between terms. The theory, utility and implementation of directed acyclic graphs is well known to one skilled in the art and has been described in the art (see for example Weiss, Mark Allen Data Structures and Algorithm Analysis in C Benjamin/Cummings, 1993, 284-288).

In an MKDAG of the present invention each node is a term found in the medical dictionary. In FIG. 3, nodes 300 (Inflammatory Bowel Disease), 302 (Crohn's Disease), 304 (Ulcerative Colitis), 306 (Diabetes), 308 (Clinical Dysentery) and 310 (Gastroenteritis) are terms belonging to the diagnosis category. Nodes 314 (Diarrhea), 316 (Rectal Bleeding) and 318 (Abdominal Pain) are terms belonging to the symptoms category. Node 322 (Insulin) is a term belonging to the medication category.

In an MKDAG of the present invention each link between two nodes represents a finite probability (that is, substantially greater than 0) of coappearance of the two linked terms in one patient. Each link has a direction. Associated with each link is a coappearance probability P(t₁, t₂) that quantifies the probability that if the first term t₁ applies to a patient, the second term t₂ will also apply to that patient.

There are two types of links, hierarchical links (326, 328, 330 and underlined in FIG. 3) and non-hierarchical links (334, 336, 338, 340, 342, 344, 346 and 348 not underlined in FIG. 3).

Hierarchical links represent a “broader than” relation between two terms of the same category and always have a probability of 1. For example, as Crohn's Disease is an Inflammatory Bowel Disease, every patient having Crohn's Disease necessarily has an Inflammatory Bowel Disease. P(Inflammatory Bowel Disease|Crohn's Disease)=1.0 (link 326).

Non-hierarchical links represent any coappearance probability that is not hierarchical. Each non-hierarchical link has an associated a priori probability that is less than or equal to 1. For example, P(Diabetes, Insulin) (link 334) is high (close to 1) as the probability a person diagnosed with diabetes using insulin as a medicament is relatively high. For example, P(Crohn's Disease, Insulin) (link 336) is low (relatively close to 0) as a patient having Crohn's Disease uses insulin only incidentally. P(Muscular Dystrophy, Alzheimer) (not depicted in FIG. 3) is very low (close to 0) as it is unlikely that a patient diagnosed as having muscular dystrophy is also diagnosed as having Alzheimer's disease.

As clear from the name, an MKDAG is acyclic, meaning that there is no group of nodes where all nodes belong to the same category and where the interconnecting links define a cycle.

Associated with each probability P(t₁, t₂) of a non-hierarchical link is a strength factor S. S has units of patients. The higher S is, the more believable and more “true” the associated a priori probability is. S is determined from the literature or by a medical expert.

Also associated with each probability P(t₁, t₂) of a non-hierarchical link is a counter C. C has units of patients and is an actual count of patients that have been identified as being associated with that term.

The utility of P(t) and associated S and C is discussed hereinbelow.

It is clear to one skilled in the art that as the probability P(t₁, t₂) of a hierarchical link is a result of a definition, there is no significance to an associated strength S or counter C.

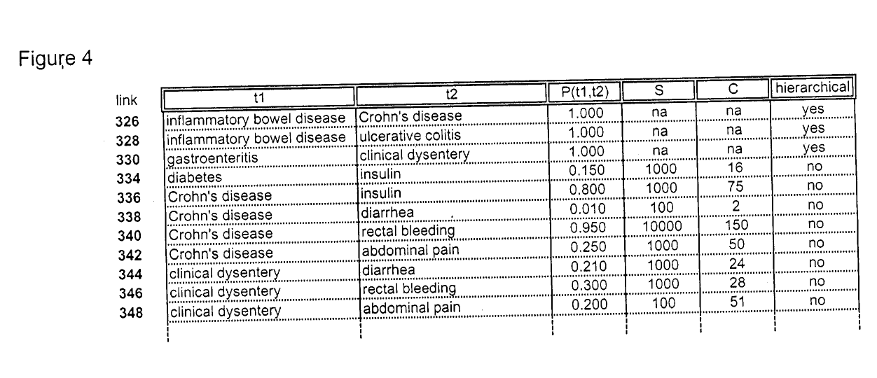

Methods of implementing the MKDAG of the present invention are clear to one skilled in the art. For example, a table of all cross terms t₁, t₂, with associated probabilities P(t₁,t₂), S and C is a preferred method of implementing an MKDAG of the present invention as depicted in FIG. 4.

Input Data Storage Structure

The utility of the present invention is increased when patient data is continuously input from medical records. The present invention is most preferably configured to input patient data from free-form medical records. The preferred process whereby data from free-form medical records is input is described in detail hereinbelow.

Several methods have been developed for converting medical text into coded data (see for example, Spyns P. “Natural language processing in medicine: an overview” in Methods Inf. Med. 1996, 35, 285-301). However no prior art method is configured to extract complementary information (e.g. dosage of medication), or to effectively infer the context of a sentence (e.g. negative forms or family history). These methods have not proposed effective methods of resolving text ambiguities, nor have systems with learning capabilities been described.

Necessary for the preferred method of free-form data input according to the present invention are two data structures, a medical synonym list and a medical record pattern list.

Medical Synonym List

A medical synonym list of the present invention, is a list of entries, each entry being a synonym or abbreviation of a term appearing in the medical dictionary. Every entry in the medical synonym list is associated with a respective term. For instance the entry “IBD” appear as a synonym for the term “Inflammatory Bowel Disease” found in the medical dictionary.

There are ambiguous entries that are synonymous with more than one term. For example the entry “CD” may be a synonym for the term “Crohn's Disease” or for the term “Clinical Dysentery”. In a medical synonym list of the present invention, ambiguous entries are indicated as being ambiguous and the possible meanings are listed.

The more comprehensive the synonym list, the greater its utility. Clearly, it is most advantageous that the synonym list be updateable (that is, new entries may be added), for example by a system administrator. The use of a synonym list of the present invention is described fully hereinbelow. Methods of implementing a synonym list as described herein are well known to one skilled in the art.

Medical Record Pattern List p A medical record pattern list is used in understanding and classifying terms found in a free-form text. A medical record pattern list is a list of associated words that appear together in medical records and can be used to understand the exact meaning of a term in the context of a given medical record. It has been found that one advantageous method of implementing a medical pattern list is by extending the well known regular expression language supported by many programming languages such as Java Version 1.4 (Sun Microsystems, Santa Clara, Calif., USA). However instead of using a “regular expression” as-is, it is preferable to enrich the language in order to include the following keywords:

a. <MEDICATION> replaces terms in the medical dictionary that belong to the medication category;

b. <DIAGNOSIS> replaces terms in the medical dictionary that belong to the diagnosis category;

c. <LAB> replaces terms in the medical dictionary that belong to the lab category;

d. <BEHAVIOR> replaces terms in the medical dictionary that belong to the behavior category;

e. <PROCEDURE> replaces terms in the medical dictionary that belong to the procedure category;

f. <SYMPTOM> replaces terms in the medical dictionary that belong to the symptom category; and

g. <UNITS> replaces terms in the medical dictionary that belong to the unit category such as mg, kg, inch, and the like.

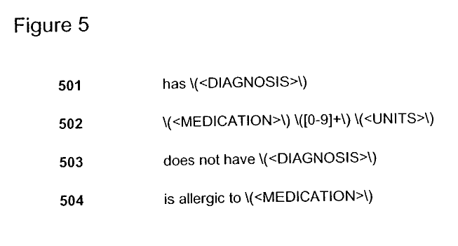

Examples of medical patterns from a medical pattern list of the present invention are listed in FIG. 5.

The more comprehensive the medical record pattern list the greater its utility. It is important to note that as patient record writing is a learned skill, a virtually complete medical list can be formulated by consulting a standard medical textbook on the subject, see for example Bickley, Lynn S. and Hoekelman, Robert A. “Bates' Guide to Physical Examination & History Taking, 7th edition”, Lippincott Williams & Wilkins Publishers; Jan. 15, 1999.

Clearly, it is most advantageous that the medical record pattern list be updateable, for example by a system administrator. The use of a medical record pattern list of the present invention is described fully hereinbelow. Methods of implementing a medical record pattern list as described herein are well known to one skilled in the art.

Modules

Actual Probability Module

As discussed above, every a priori probability P (excepting those associated with hierarchical links) is associated with a strength value S indicating how believable the probability is and a counter C, indicating the actual number of patients that have been identified as actually having the medical situation associated with the probability. When a request is made for a probability the actual probability module returns a probability value Pa(t) based on the a priori probability corrected by the accumulated knowledge of the system of the present invention using Equation 1:

Actual_Probability=Original_Probability·Strength+Counter/Total Number of Patients+Strength

The actual probability module is used to return the value of a single event, for example, “What is the chance of a patient having the condition of diabetes”. For such a question, the actual probability module consults the medical dictionary for P(diabetes) with associated S and C values to calculate the actual probability.

In analogy to the calculation of Pa(t) from P(t) and the associated S and C using Equation 1, one skilled in the art can also implement the calculation of actual probability Pa(t, a) or P(t₁,t₂) (for non-hierarchical links) and the associated S and C.

Coappearance Probability Module

An advantage of the present invention is the ability to determine the coappearance probability of two terms. This is preferably done by using a coappearance probability module. Submitted to the coappearance probability module is the question P(tₐ, t₁, . . . , tₙ) and returned is P(tₐ|t₁, . . . , tₙ) the probability that an arbitrary patient having the terms t₁, . . . , tₙ also has tₐ despite the fact that tₐ does not appear in the patient record.

In general, a coappearance probability is calculated by consulting a MKDAG.

In the simplest case determined is the probability of appearance of tₐ if t_{b} appears in the patient record, that is the value of P(tₐ|t_{b}).

If there a link between the respective nodes corresponding to the two terms this is a simple matter involving determining the a priori probability P(tₐ, t_{b}) associated with the link and then if the link is not-hierarchical, calculating an actual coappearance probability Pa(tₐ, t_{b}) using the associated values of S and C in a manner analogous to that described hereinabove.

If there is a single path of length m>1 between tₐ and t_{b} consisting of m terms tᵢ then P(tₐ|t_{b}) is calculated using equation 2:

$$P ( Desirabl e Term \vert {term}_{i} ) = {\prod }_{j = 2}^{m} P ( \text{path} ( j - 1 ) \vert path ( j ) )$$

where:

path(1)=desirable term (the first term in the path, ta); and

path(m)=the last term in the path, tb.

If there are l paths (l>1) of lengths m₁ . . . mₗ respectively between tₐ and t_{b}, P(tₐ|t_{b}) is calculated using equation 3:

$$P ( Desirable Term \vert {term}_{i} ) = {\sum }_{k = 1}^{J} {\prod }_{j = 2}^{{m}_{k}} P ( {path}_{k} ( j - 1 ) \vert {path}_{k} ( j ) ) - {\prod }_{k = 1}^{j} {\prod }_{j = 2}^{{m}_{k}} P ( {path}_{k} ( j - 1 ) \vert {path}_{k} ( j ) )$$

In a more complex situation, the coappearance probability module is required to return the coappearance probability of a term tₐ with a number of other terms, P(tₐ|t₁ . . . tᵢ). This is done analogously to the process above, using a modification of the Naive Bayes methodology, as described below in equation 5.

Data Input Module

A data input module of the present invention is configured to store patient data in the relational database using the MKDAG and the medical dictionary, and in the process increase the knowledge contained in the MKDAG. It is preferable that the data input module be configured to input patient from free-form text documents.

As is clear from the description of the database, the medical dictionary and MKDAG of the present invention, an increase of utility of the present invention is attained by the learning ability inherent in the present invention. In prior art expert systems and databases, knowledge stored in the system is fixed and uniform. Knowledge can be updated but knowledge increase is not inherent. There is no way to evaluate and judge the quality of the knowledge. In contrast, in the present invention input of every new patient record increases the knowledge of the system. Even more importantly, the knowledge becomes detailed, fine-tuned and specific for the patient population that is applicable to the user of the system. A system of the present invention used in a geriatric hospital is soon optimized for and increases knowledge in geriatric medicine. In contrast, a system of the present invention used by a central health authority is soon optimized for and increases knowledge in general medicine.

By increasing knowledge is meant both literally more knowledge, but also confirmation of previously held assumptions or facts that may or may not be valid. Specifically, every patient record that is input validates a priori knowledge, generates new relationships between terms and corrects the probability associated with a medical situation.

In a less preferred embodiment of a data input module of the present invention, patient data is input into the system of the present invention by using structured forms and questionnaires. In a preferred embodiment, the data input module receives free-form text medical records and automatically inputs data therefrom.

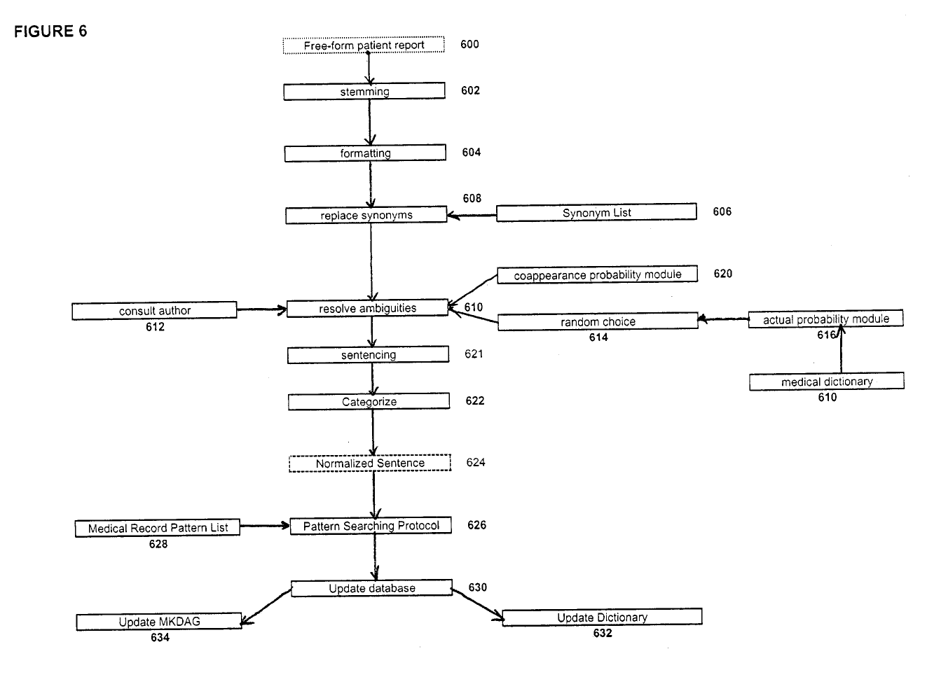

For clarity, the description immediately hereinbelow and the flowchart depicted in FIG. 6 is directed at describing a free-form text data input module. One skilled in the art can readily adapt the description below for implementing formatted data input.

A free-form text document 600 including a medical record undergoes a stemming step 602, a process with which one skilled in the art is well acquainted (see for example Sparck Jones, Karen, and Peter Willet, 1997, Readings in Information Retrieval, San Francisco: Morgan Kaufmann, ISBN 1-55860-454-4).

Stemming 602 is followed by a formatting step 604, a process whereby amongst other:

a. Numbers written in text (e.g. “twenty two”) are replaced with corresponding digits (“22”);

b. Dates are identified and converted to a uniform format, for example the ISO 8601 standard form. For example the dates “Jun. 23, 1998”, “Jun. 23, 1998”, “Jun. 23, 1997” and “Jun. 23, 1997” are all replaced with Jun. 23, 1998;

c. Redundant spaces are removed; and

d. A “find and replace” procedure is performed using a suitable list of predetermined “finds” and corresponding “replaces”. For instance if Finds={doesn't, isn't} and Replaces={does not, is not} are supplied, then any appearance of “doesn't” is replaced with “does not” and any appearance of “isn't” is replaced with “is not”.

Using a synonym list 606 of the present invention, words that appear as entries in synonym list 606 are matched 608 with equivalent terms that appear in a medical dictionary 610. Ambiguous terms are marked as such.

Term ambiguities are resolved, 610. There are a number of methods that can be used to resolve ambiguities.

One method of resolving ambiguities is that the author of the text can be asked to resolve the ambiguity, for example by an automatic internal electronic mail message, 612.

Another method of resolving ambiguities is that one of the possible meanings is randomly chosen 614, either with equal probability or by an appearance probability calculated with the help of the actual probability module 616. For example, given an ambiguity with either the meaning t₁ or t₂, Pa(t₁) and Pa(t₂) are returned by the actual probability module based on P(t₁) and P(t₂) appearing in medical dictionary 610. The preferred meaning is then chosen based on the two relative probabilities.

Although such a random determination inserts some errors into the system, it has been found that the present invention is robust enough so that such errors do not significantly adversely effect data integrity.

Another and preferred method of resolving ambiguities is by evaluating the chance of coappearance of the various possible terms (that define the ambiguity) with non-ambiguous terms appearing in the text being examined, by using the coappearance probability module 620 and Equation 4:

$${max}_{{Ambiguous}_{i} ∈ Ambiguous} \frac{{\prod }_{j = 1}^{m} p ( {Ambiguous}_{i} \vert {term}_{j} )}{{p ( {Ambiguous}_{i} )}^{n - 1}}$$

When the probability of one of the possible terms is overwhelmingly greater, that term is selected as the proper meaning for the ambiguity. When the probabilities are similar, then any of the other ambiguity-resolving methods can be applied.

In the following step, the formatted text undergoes “sentencing”, that is divided into sentences by searching for terminating signs, 621.

For sentencing a list of termination strings is supplied, for example Termination={“.”, “?”, “!!!”}. For each termination string, an exception list is given, listing the circumstances the string will not be treated as a termination string.

The exception list is defined as a list of strings written in regular expression language. For example for the termination string “.” an exception list {“Dr.”, “[0-9].[0-9]”} may be appropriate to avoid misinterpretation of the sentence:

The patient has visited Dr. Parker in Jan. 1, 2002.

Following sentencing 621, for each sentence identified:

Each term in the sentence is categorized 622 replaced by the name of the category to which it belongs (found in the medical dictionary 610) between the “<” and the “>”. These matches are kept in the computer memory. Then each term is replaced with its category resulting:

For instance the sentence:

The patient is diagnosed with hypertension and diabetes.

is changed to:

The patient is diagnosed with <DIAGNOSIS> and <DIAGNOSIS>

Adding Data to the Database

The resulting normalized sentence 624 is analyzed by a pattern searching protocol 624 with the help of the medical record pattern list 628. A single pattern or a combination of patterns identified is a new item of data.

The mapping of data from a text onto the database (step 628 in FIG. 6) with the help of a pattern searching protocol is known to and easily implementable to one skilled in the art. First, it is determined if the patient exists in the database. If not, a new patient record is created in the patient table of the database and salient data, found using the pattern searching protocol, is recorded therein. Once a patient record exists in the patient table, then for each sentence its data items are mapped according to the pattern selected for that sentence in the appropriate category table of the database. In order to perform the above task, a mapping information is supplied with each pattern indicating the appropriate field and category table of the database, in which each data item should be stored.

For example the pattern:

\(<MEDICATION>\)\([0-9]+\)\(<UNITS>\)

is mapped as following:

1. The medical term matched with <MEDICATION> should be inserted into the field medication in medication table;

2. The number matched by \([0-9]+\) should be inserted into dosage field in medication table; and

3. The unit term matched with \(<UNITS>\) should be inserted into the units field in medication table.

It is important to note that it is preferred that there be no updating of data, that is old records and entries are not amended, changed or erased. Rather, new data is added as a new record. It has been found that the consequent redundancy has only a minimal negative effect on database integrity.

Updating the Medical Dictionary and the MKDAG

Every update of data can lead to an update of the medical dictionary (step 632 in FIG. 6) and the MKDAG (step 634 in FIG. 6). Such updating involves incrementing a counter C associated with a probability P. As described above, every new database record involves associating at least one term with a patient. During the process of adding a new record, the database is examined to see if the term in the new record has been previously associated with the patient. If the term has not been previously associated with the patient, then the counters C of probabilities P(t) and P(t, a) associated with the term in the medical dictionary are incremented. In addition, by consulting the MKDAG, terms having a “broader than” relationship to the new term are identified. The counters C associated with the probabilities P(t) and P(t, a) of the “broader than” terms are also incremented.

Coappearance counters associated with non-hierarchical links in the MKDAG are also incremented. For every pair of terms found in the patient medical record being input not having a hierarchical relation:

a. if a non-hierarchical link exists, the corresponding coappearance probability counter is incremented; or

b. if no link exists, a new link with an associated counter C is created (having an S of 0) and the counter set to 1.

In such a way, new relationships between terms are discovered. It is clearly preferable that all links ever created be preserved. It has been found, however, that retaining all links is practically difficult and makes a real-life implementation of the present invention impracticably slow. One feature that has been found to only slightly compromise the quality of the knowledge stored by a system of the present invention is to intermittently delete statistically insignificant links. For example, with every 10% increase of records a statistical hypothesis analysis is performed (see for instance Walpole, R. E. & Myers, R. H. (1986). “Probability and Statistics for Engineers and Scientists”, Macmillan Publishing Co., New York) Links that are statistically significant are retained while statistically insignificant links are deleted.

System Initiated Data Request Module

Optionally, a module for automatically formulating a request for missing data is provided. A list of patients with an important attribute missing from the database is made and a report listing these patients is sent, for example to the system administrator. One skilled in the art can easily implement a system initiated data request module based on the description hereinabove.

Relationship Identifying Module

As is clear to one skilled in the art, two main types of knowledge are automatically and continuously generated and confirmed by the system of the present invention.

In the medical dictionary, counters C continuously record what an actual appearance probability Pa(t) or Pa(t, a) of a term is. This knowledge can be extracted to either confirm or update the a priori probability P(t) or P(t, a).

In the MKDAG, counters C associated with coappearance probabilities P(t₁, t₂) continuously record what an actual coappearance probability Pa(t₁, t₂) of two terms is. This knowledge can be extracted to either confirm or update the respective a priori probability P(t₁, t₂).

No less exciting, in the MKDAG new correlations between terms, as expressed by new links having associated coappearance probabilities are continuously recorded and evaluated for significance.

As is clear to one skilled in the art, the various types of new knowledge can be easily extracted and analyzed due to the unique characteristics of the present invention.

Query Module

The unique characteristics of the present invention allow accurate responses to complex medical queries. In general, a query is a list of inclusion/exclusion criteria and the response to a query is a number and or identification of patients that suit the criteria. Unique to the present invention is that associated with each patient is also a probability expressing what the chance is that the patient fulfils the conditions of the query.

Query Composition Module

According to the present invention a query is made up of one or more conditions and a condition is made up of one or more clauses parsed using a Boolean AND, OR and NOT.

A clause is a phrase that includes one term from one category. For example “patient taking the medication insulin” is a clause.

One or more clauses are added together to make up one condition. Typically, although not necessarily, a condition is made of two or three clauses. For example, “patient taking the medication insulin AND NOT patient diagnosed diabetes” is a condition.

One or more conditions typically make up a query.

It is important to note that the three-tiered structure of clause/condition/query of the present invention is exceptionally convenient as it mirrors the inclusion/exclusion structure of queries provided by persons in the field of medical data inquiries. One skilled in the art recognizes that a query of the present invention corresponds to an inclusion/exclusion list, while each row of the list corresponds to a condition of the present invention.

As is described immediately hereinbelow, the present invention is exceptionally suited to answering queries having the three-tiered structure of clause/condition/query.

In a first step, a query must be input to a system of the present invention. According to a preferred embodiment of the present invention, a query is formulated condition by condition. Each condition is formulated using a user-interface providing a limited number of predesigned clauses from which to choose where each predesigned clause includes a term from the dictionary.

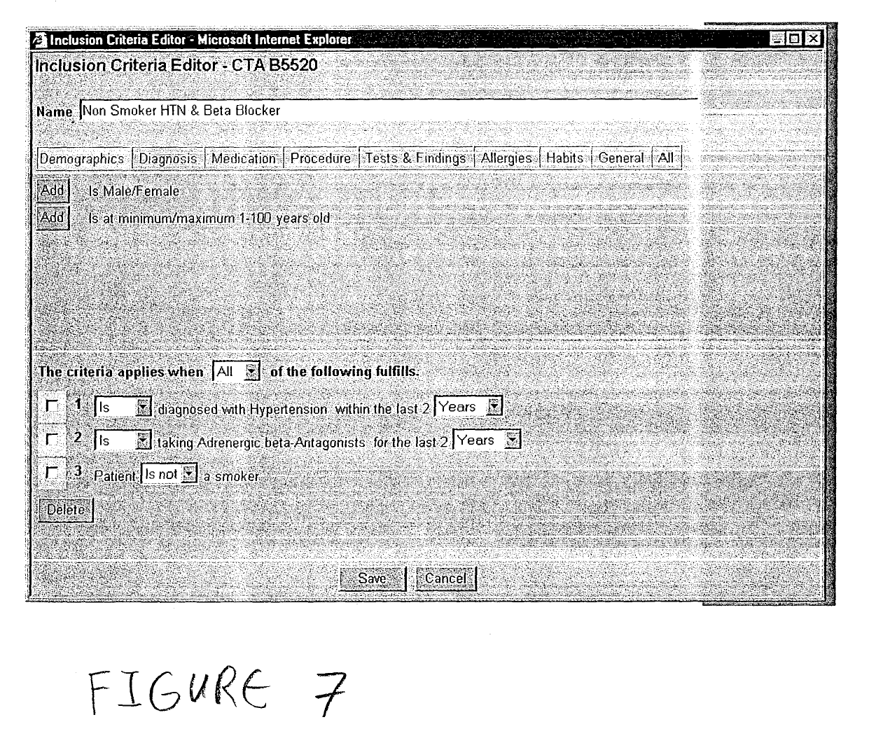

Such a user interface is easily implemented, for example, on a computer terminal equipped with a mouse and keyboard for input, a display monitor for output, and software allowing implementation of “Wizards” and “Menus” by one skilled in the art. An illustrative example of a user interface is depicted in FIG. 7.

Query Compiler Module

Once a query is formulated, the query is sent to a query compiler module. For each patient, for each condition, for each clause including the term ta, the database is consulted to see if the patient fulfils the clause. If the clause is fulfilled, the score for that clause is 1. If the clause is not fulfilled, the score for that clause is calculated based on the coappearance probability P(tₐ|t₁. . . tₙ) of the term tₐ with other terms t₁ . . . tₙ appearing in the records of the patient using the coappearance probability module and equation 5:

$$P ( Desirable Term \vert {term}_{i} ; ∀ {term}_{j} ∈ Record ) ≅ \frac{\frac{{\prod P ( Desirable Term \vert {term}_{i} )}_{∀ {term}_{j} ∈ Record}^{}}{{P ( Desirable term )}^{n - 1}}}{\frac{{\prod }_{∀ {term}_{j} ∈ Record}^{} P ( Desirable Term \vert {term}_{i} )}{{P ( Desirable Term )}^{n - 1}} + \frac{{\prod }_{∀ {term}_{j} εRecord}^{} ( 1 - P ( Desirable Term \text{\textbar} {term}_{i} ) )}{{( 1 - P ( Desirable Term ) )}^{n - 1}}}$$

where n is the number of different terms in the records of the patient's record, and the P(t₁|t₂) are calculated using the coappearance probability module. As a result, the probability that the patient satisfies a clause even though there is no explicit indication of that in the patient records is estimated.

Once all constituent clauses of a single condition relating to one patient are scored, the condition score is calculated. The calculation of a condition score can be performed according to any method known in the art. The inventor has found that preferred is the use of “fuzzy logic” type meaning for the Boolean operators. Specifically, every pair of clauses separated by a Boolean operator are sequentially evaluated where:

a) for an AND operation, the minimum of the two clause scores is the pair score;

b) for an OR operation, the maximum of the two clause scores is the pair score;

c) for a NOT operation the 1-score of the clause score is taken.

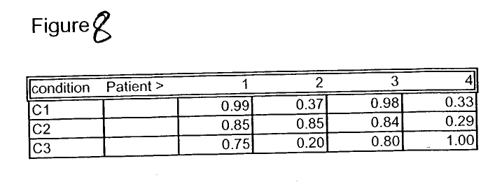

At the end of the process a single condition score is found. Once all the conditions of all patients have been scored, a vector of condition scores is produced for each patient as a response to the query. Vectors of condition scores for 4 patients for a query composed of three conditions C1, C2 and C3 are depicted in FIG. 8.

Although in some embodiments of the present invention the vector of condition scores is sufficient or even desired, in a preferred embodiment the vector of condition scores is converted to a single scalar query score.

In one, preferred, method of converting a vector of condition scores to a single scalar score is as follows:

a) given a query with p conditions;

b) for each patient i from n patients optimization equation 6 is solved, where the target value is the scalar query score for that patient:

$$max {\sum }_{j = 1}^{P} {α}_{j} \cdot {S}_{i , j}$$

$$s . t . \\ \begin{matrix}{\sum }_{j = 1}^{p} {α}_{j} \cdot {S}_{i , j} <= 1 & ∀ i = 1 , … , n \\ {α}_{j} >= 0 & ∀ j = 1 , . . . , p\end{matrix}$$

A given scalar query score is an indication of the relative probability that a respective patient fulfils a query. A query score of 1 indicates that the patient certainly fulfils the conditions of the query. A query score of 0 indicates that the patient certainly does not fulfil the conditions of the query. An intermediate query score indicates that the patient may fulfil the conditions of the query, where the closer the score is to 1, the greater the chance is that the patient fulfils the conditions of the query.

In some cases each condition is assigned a threshold score. Patients having a condition score below the threshold score are assigned a query score of 0.

Once a query score of all patients has been calculated, the poser of a query is presented with a list where a count (and if desired, identity) of all patients fulfilling the conditions of the query appears. Further, patients that may fulfil the conditions of the query (that is, have a score between 0 and 1) are also listed with a respective query score.

Using prior art databases with prior art SQL, a query response includes only two groups of patients: those fulfilling the conditions of the query and those not fulfilling the conditions. In contrast, the present invention provides in addition to the two groups a third group of patients, those who might fulfil the conditions of the query.

A query response such as that provided by the present invention including possible matches as provided by the present invention is highly desirable, for example, when choosing candidates for clinical trials. It is important to note that an added advantage of the present invention for choosing candidates for clinical trials is the ease with which complete deidentification is done even though the quality of the query results are competitive with a manual search of patient medical records.

Efficiency of the Query Compiler Module

As is clear to one skilled in the art, the efficiency of a query to a large database is of critical importance. The unique data structure of the present invention allows a query to be processed in an order for high efficiency. For this purpose, each query is submitted to a query compiler module.

In a preferred embodiment, a query compiler module performs steps including:

i. sort all clauses by probability (based on P(t)) so that the least probable clauses are considered first;

ii. put the sorted clauses in an ordered set A;

iii. let i=1;

iv. remove the first clause (denoted as FC) in set A and search the database for patients fulfilling this clause. Store results in temporary table number i. If A is empty stop;

v. remove from A all clauses that co-appeared with FC in the same condition;

vi. run all conditions that contains FC on patients stored in temporary table number i and store the results on the appropriate condition table result;

vii. increase i by one;

viii. goto i.

Implementation

One skilled in the art of information science is able, upon reading the description hereinabove, to implement the modules necessary for performing the present invention as software programs to be used with a general-purpose computer.

The utility of the present invention is in large part dependent on the use of the MKDAG. The use of an MKDAG allows for the simple and efficient implementation of the coappearance probability module. To one skilled in the art it is immediately clear that, in turn, the coappearance probability module allows a user of the present invention heretofore-unknown capabilities to identify patients according to specified criteria.

Using prior art methods, once can retrieve from a database only what is explicitly found therein. For example, when searching for patients having diabetes, only these explicitly marked as having diabetes are identified as diabetics. In contrast, using the present invention, patients having diabetes but not explicitly listed as such in the database are also identified as diabetics. More important is the fact that the coappearance probability allows identification of patients whom might have a condition even if the condition is not explicitly listed in the patient records. The might is quantified by being expressed as a probability. Thus, an overweight patient who is prescribed insulin will be identified as a probable diabetic even if diabetes is not explicitly listed in the patient records.

Further, as is clear from the description herein, the present invention makes hitherto unavailable information available, despite incompleteness of patient record data.

The present invention provides a number of technical effects. One of the most important technical effects is in the saving of filing space and time. Using prior art methods, patient medical records must be kept available for perusal and thus are not stored in an archive. When it is necessary to obtain information from a patient medical record, the medical record must be found and examined. In contrast, the present invention extracts substantially all salient data and information from a patient record and stores it in a database where, as described above, the data is accessible.

An additional important technical effect is of concentrating all salient information concerning a single patient in a single accessible location. In prior art methods, medical records from different medical institution departments are kept in differing locale and are accessible, only with difficulty, to medical personnel in other departments. In contrast, the present invention allows all salient medical data to be easily accessible.

The present invention is not limited to the embodiment described herein but also relates to all kinds of modifications thereof, insofar as they are within the scope of the claims. Specifically, although the description of the present invention herein is directed at the field of medical data management, there are other fields of information management to which the present invention can be applied with only minor modifications.

1. A software system for accessibly storing information from medical data, the software system fixed in a machine readable medium, the software system comprising:
a) a dictionary of terms, each one of said terms having no more than one meaning;
b) a relational database storing person-dependent data; and
c) an directed acyclic graph made up of nodes and links between pairs of nodes wherein:
i. a node represents one said term; and
ii. a link between two nodes represents a finite probability that two terms corresponding to said two nodes coappear in a record of a person in said database
wherein each database record in said database corresponds to a single person and some of said terms are attributes in said database.

2. The system of claim 1 wherein each one of said terms in said dictionary is classified as belonging to a category.

3. The system of claim 1 wherein associated with said terms is a respective term appearance probability, said respective term appearance probability being related to a probability that a respective term appear in a record of a person in said database.

4. The system of claim 3 wherein said term appearance probability is dependent on the number of times a respective term appears in said database.

5. The system of claim 3 wherein said term appearance probability is dependent on an a priori probability that a respective term appear in a record of a person in said database.

6. The system of claim 1 wherein associated with said links is a respective term coappearance probability, said respective term coappearance probability being related to a probability that said two terms corresponding to said two nodes coappear in a record of a person in said database.

7. The system of claim 6 wherein said term coappearance probability is dependent on the number of times said two respective terms coappear in a record of a person in said database.

8. The system of claim 1 further comprising:
d) a data input module configured to input a patient record, extract salient data from said patient record, and to store said salient data in said database.

9. The system of claim 8 further comprising wherein said data input module is configured to extract salient data from a free-form patient record.

10. The system of claim 1 further comprising:
e) a relationship identifying module configured to determine a relationship probability, said relationship probability being related to a probability that a nonappearing term, said nonappearing term not appearing in a record of a specific person in said database, is applicable to said specific person.

11. A method for accessibly storing medical data comprising:
a) providing a dictionary of terms, each one of said terms having no more than one meaning;
b) providing a relational database wherein each database record in said database corresponds to a single person and said medical terms are attributes in said database;
c) describing relationships between said terms using a directed acyclic graph comprising nodes and links between pairs of nodes wherein:
i. a node represents one said term; and
ii. a link between two nodes represents a finite probability that two terms corresponding to said two nodes coappear in a database record of a person in said database;
d) for a plurality of persons, from at least one medical record relating to each one of said persons, extracting at least one data item from said at least one medical record, wherein a data item indicates the applicability of at least one of said plurality of medical terms to a respective person; and
e) storing extracted data items in said relational database.

12. The method of claim 11 wherein each one of said terms in said dictionary is classified as belonging to a category.

13. The method of claim 11 wherein associated with said terms is a respective term appearance probability, said respective term appearance probability being related to a probability that a respective term appear in a record of a person in said database.

14. The method of claim 13 wherein said term appearance probability is dependent on the number of times a respective term appears in said database.

15. The method of claim 13 wherein said term appearance probability is dependent on an a priori probability that a respective term appear in a record of a person in said database.

16. The method of claim 11 wherein associated with said links is a respective term coappearance probability, said respective term coappearance probability being related to a probability that said two terms corresponding to said two nodes coappear in a record of a person in said database.

17. The method of claim 16 wherein said term coappearance probability is dependent on the number of times said two respective terms coappear in a record of a person in said database.

18. The method of claim 11 wherein said at least one medical record is a free-form medical record.
